(19) United States
(12) Patent Application Publication
(10) Pub. No.: US 2008/0029936 A1
(43) Pub. Date: Feb. 7, 2008

(54) APPARATUS AND METHOD FOR MANUFACTURING HOLLOW ARTICLES MADE FROM THERMOPLASTIC MATERIALS BY BLOW MOLDING

(75) Inventor: Gottfried Mehnert, Berlin (DE)

Correspondence Address: PATZIK, FRANK & SAMOTNY LTD., 150 SOUTH WACKER DRIVE, SUITE 1500, CHICAGO, IL, 60606, US

(73) Assignee: BEKUM Maschinenfabriken GmbH, Berlin (DE)

(21) Appl. No.: 11/832,746

(22) Filed: Aug. 2, 2007

(30) Foreign Application Priority Data
Aug. 3, 2006 (DE) 102006036644.1

(51) Int. Cl. B29C 49/04; B29C 49/28

(52) U.S. Cl. 264/523; 425/532

(57) ABSTRACT

In a blow molding machine comprising a preform station having arranged thereon at least one extruder including at least one downstream parison head, comprising at least one blowing station on which a blowing device is arranged with at least one blowing and calibrating mandrel, and at least one mold system having a blow mold arranged underneath the at least one parison head to accommodate the thermally plasticated parison extruded out of the at least one parison head between the opened mold halves, the blow mold being moved into the blowing station after the mold halves have been closed, wherein the blowing station is arranged in front of the preform station and in parallel with the mold system.

This application claims benefit of German patent application no. 10 2006 036 644.1, filed Aug. 3, 2006, which is incorporated herein in its entirety by reference.

### FIELD OF THE INVENTION

The present invention relates to a blow molding machine and to a method for the manufacture of hollow articles from thermoplastic materials by blow molding, the operation being carried out “under heat”.

### BACKGROUND OF THE INVENTION

In said blow molding method a thermally plasticated tube or parison which is extruded continuously or discontinuously from the die of a parison head arranged downstream of an extruder and which is grasped by a previously opened blow mold while the mold parts are being closed is severed from the following material and then inflated by introduction of a blowing medium into the parison portion disposed in the mold, which is called “preform”, and is forced against the mold cavity wall. When preforms are formed in this manner from an extruded parison formed in the parison head from the material emerging from an extruder, the term “extrusion blow molding” is used in contrast to injection blow molding.

A much-used method of this type consists of the following steps: from the die of the parison head forming the thermally plasticated parison, a parison is extruded between the open parts of a blow mold and, when said parison has reached the required length, said mold closes around this parison portion, which then forms the preform and is subsequently severed from the following material. The closed mold with the preform is then moved in parallel in the direction of the mold-parting plane out of this parison or preform station into a blowing station, in which a blowing and calibrating mandrel is inserted from above into an end of the preform that is kept open in the mold. Mostly at the same time, the blowing medium is introduced on the one hand through the blowing mandrel into the preform for expanding said preform until contact with the mold cavity wall and the filling and emptying opening of the hollow article, mostly a so-called “neck”, is formed on the other hand through a corresponding shape of the mandrel by press forming between a corresponding part of the mold cavity wall and the circumference of the blowing mandrel.

While the preform in the closed mold in the blowing station is being shaped to form the hollow article and subsequently cooled by means of cooling channels incorporated into the mold, a new parison portion already emerges from the parison die in the preform station. This process can be time-coordinated with the shaping and cooling as well as removal of the finish-blown hollow article in the blowing station in such a way that a preform of precisely the correct length is present in the preform station when the opened mold has traveled back from the blowing station into the preform station to receive a new preform. This method is also known as “shuttle method” or “method with top calibration” or “top blowing”.

In methods of the aforementioned kinds for producing hollow articles from plastics by inflating a preform in a blow mold, the time passing from the reception of a preform in the blow mold until the subsequent reception of a new preform in the same mold is called cycle time.

To increase the output of a blow molding machine, it is known that the number of cavities arranged side by side and in parallel is increased within a mold system, which has the consequence that the closing plates for receiving the blow molds are enlarged. As a consequence, in conventional blow molding machines, the travel paths of the mold system from the parison head position to the blowing station are considerably increased, which makes the cycle times of a blow molding system of the above-mentioned type much longer.

### SUMMARY OF THE INVENTION

It is the object of the present invention to provide an apparatus and a method for the manufacture of hollow articles from plastics, with which hollow articles can be manufactured while the cycle time is noticeably shorted in comparison with the above-mentioned method.

In preferred embodiments, for increasing the flexibility of such blow molding systems the manufacturing process should be possible with “top blowing” or “bottom blowing” or also the two together and at the same time with the so-called “tandem blowing”.

According to the invention, the blowing station of the blow molding machine is arranged frontally in front of the preform station, preferably such that the mold system is movable with the blow mold in a direction perpendicular to, i.e. at a right angle with, the mold-parting plane between the preform station and the blowing station. The distance between the preform station and the blowing station is here preferably minimal and just predetermined by the geometrical dimensions of the at least one parison head (or parison heads arranged side by side along a line) and the blowing device.

This configuration has the consequence that the travel paths of the mold system from the preform station to the blowing station and back are minimized, whereby the cycle times of the blowing machine according to the invention are considerably reduced.

Especially when two mold systems are provided that are alternatingly movable between the joint preform station and the two associated blowing stations, the blowing stations are frontally arranged in front of the preform station such that they are moved obliquely with respect to the mold-parting plane. This can be accomplished by two superimposed hydraulic carriage drives that are vertically positioned relative to one another, as is schematically shown in the movement triangle of FIGS. 10 to 12.

Furthermore, according to the invention the blowing device may be at least one stationarily-arranged top blowing device. To this end, it is suggested with advantage that the blowing device should be liftable such that the at least one inflated hollow article held on the blowing and calibrating mandrel (mostly the inflated hollow articles held on a plurality of blowing and calibrating mandrels arranged along a line) does not impede the movement of the blow mold to the preform station.

The blowing device may also be at least one stationarily-arranged bottom blowing device, and it may then be envisaged in an advantageous development that said device can be lowered to such an extent that the movement of the blow mold towards the preform station is not impeded by the inflated hollow article(s).

According to a further embodiment, the blowing device may comprise both at least one stationarily-arranged top blowing device and at least one stationarily-arranged bottom blowing device, which permits the formation of two superposed hollow articles in the blow mold.

When two mold systems are preferably movable, starting from the preform station, obliquely relative to the mold-parting plane, the two associated blowing stations are arranged not directly frontally in front of the preform station, but are offset laterally to the right and left side. This is a so-called “double shuttle machine”. As a rule, a single mold system may also be movable obliquely relative to the mold-parting plane towards a frontal and thereby laterally offset blowing station.

According to the method of the invention, the at least one blow mold of the blow molding machine is not moved, as is standard in the prior art, in parallel with its mold-parting plane (in the front view on the preform station to the right or left side), but the blow mold is moved vertically or obliquely relative to its mold-parting plane to the blowing station arranged directly frontally or laterally offset in front of the preform station, whereby the distance to be covered, and thus the cycle time, is reduced considerably. The blowing and calibrating mandrels are advantageously lifted with the inflated hollow articles held thereon on the blowing station in the case of a top blowing device to such an extent or are lowered in the case of a bottom blowing device to such an extent that the opened blow mold can be returned underneath the parison heads of the preform station. The thermally plasticated parisons can be extruded from the parison heads either continuously or discontinuously. The extruder with the parison head may be arranged to be movable along a curvature or along a straight vertical path towards the top or the bottom.

### BRIEF DESCRIPTION OF THE DRAWINGS

Embodiments of the blow molding machine according to the invention shall now be described with reference to the attached drawings, in which:

FIG. 1 is an elevated side view of an embodiment of the blow molding machine with a top blowing device raised, the mold system opened and the movable mold system in position.

FIG. 2 is an elevated side view of the blow molding machine of FIG. 1 with the mold system closed, the movable mold system in position, and the extruder ready for vertical lifting, wherein the severing device severs parison from the preform clamped in the mold.

FIG. 3 is an elevated side view of the blow molding machine of FIG. 1 with the mold system closed, the movable mold system in position, the top blowing device moved into the preform, and the extruder vertically lifted.

FIG. 4 is an elevated side view of an embodiment of a blow molding machine of the present invention with a bottom blowing device moved downwards, the mold system opened, and the movable mold system in position.

FIG. 5 is an elevated side view of the blow molding machine of FIG. 4 with the mold system closed, the movable mold system in position, and the extruder ready for vertical lifting, wherein the severing device severs parison from the preform clamped in the mold.

FIG. 6 is an elevated side view of the blow molding machine of FIG. 4 with the mold system closed, the movable mold system in position, the bottom blowing device moved into the preform, and the extruder vertically lifted.

FIG. 7 is an elevated side view of an embodiment of a blow molding machine of the present invention with the mold system opened, the movable mold system in position, a top blowing device raised, and a bottom blowing device moved downwards.

FIG. 8 is an elevated side view of the blow molding machine of FIG. 7 with the mold system closed, the movable mold system in position, and the extruder ready for vertical lifting, wherein the severing device severs parison from the preform clamped in the mold.

FIG. 9 is an elevated side view of the blow molding machine of FIG. 7 with the mold system closed, the movable mold system in position, the top blowing device and bottom blowing device moved into the preform, and the extruder vertically lifted.

FIG. 10 is a top plan view of the blow molding machine of FIG. 1 without the extruder in the variant top blowing device.

FIG. 11 is a top plan view of the blow molding machine of FIG. 1 showing the general principle of a one-side machine (single shuttle machine) and without the extruder in the variant top blowing device.

FIG. 12 is a top plan view of the blow molding machine of FIG. 1 showing the general principle of a two-side machine (double shuttle machine) and without the extruder in the variant top blowing device.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

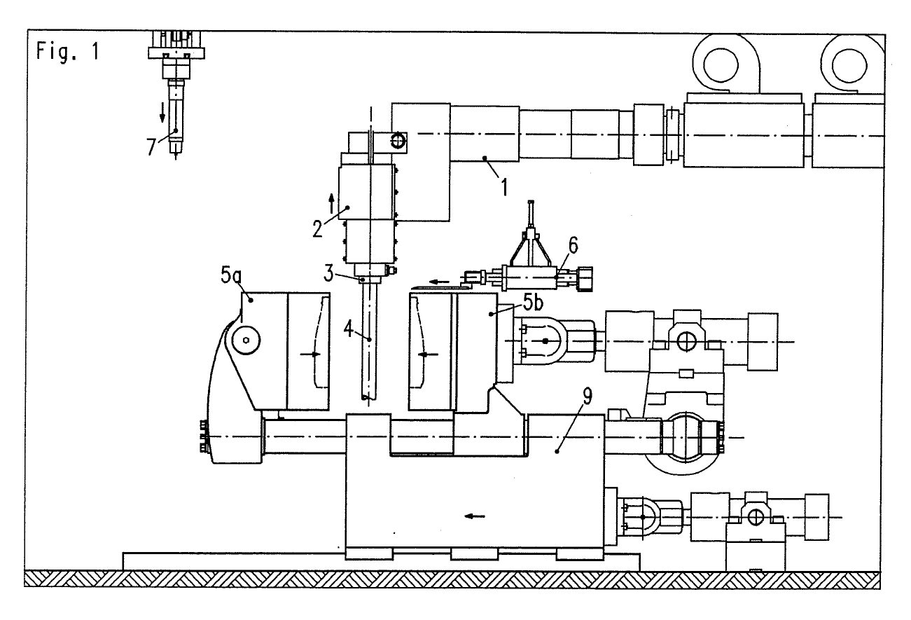

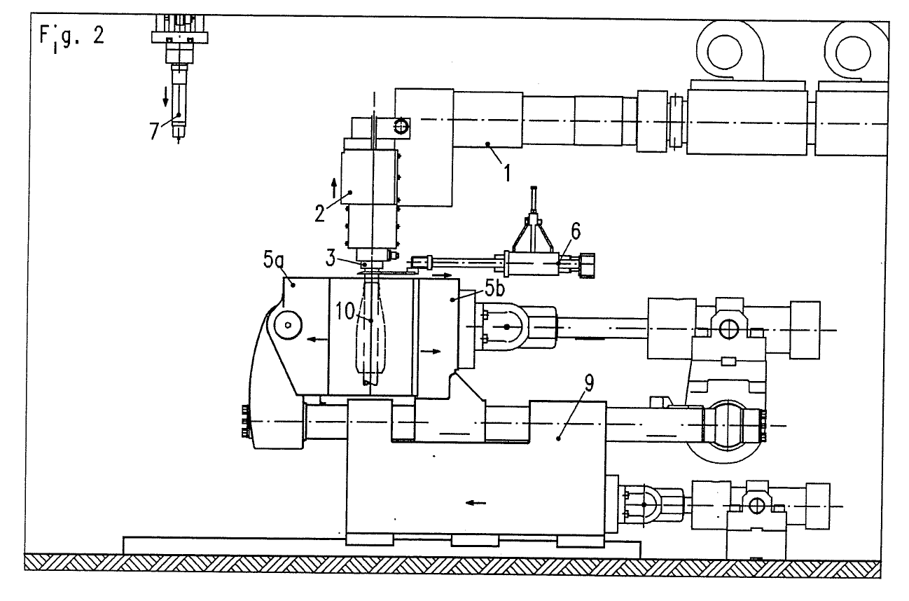

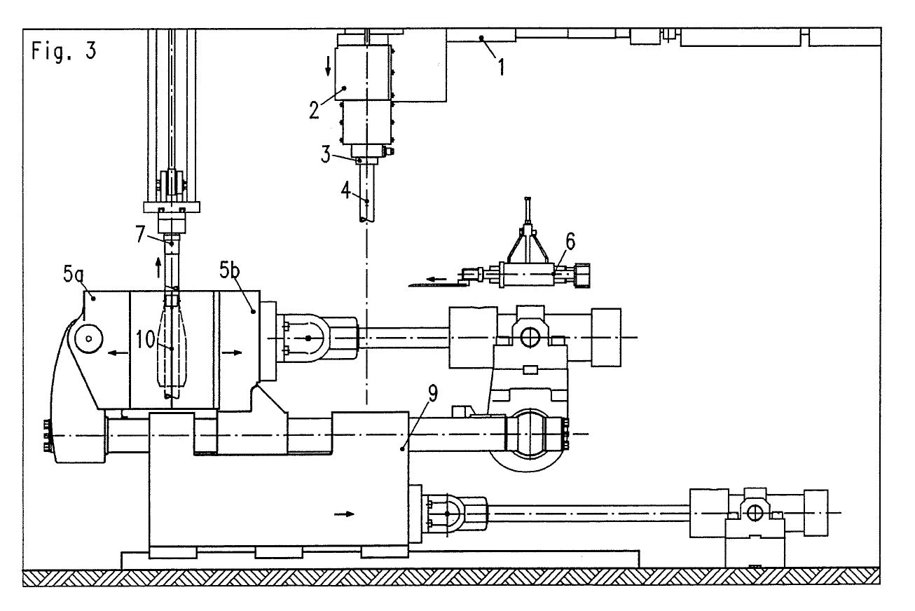

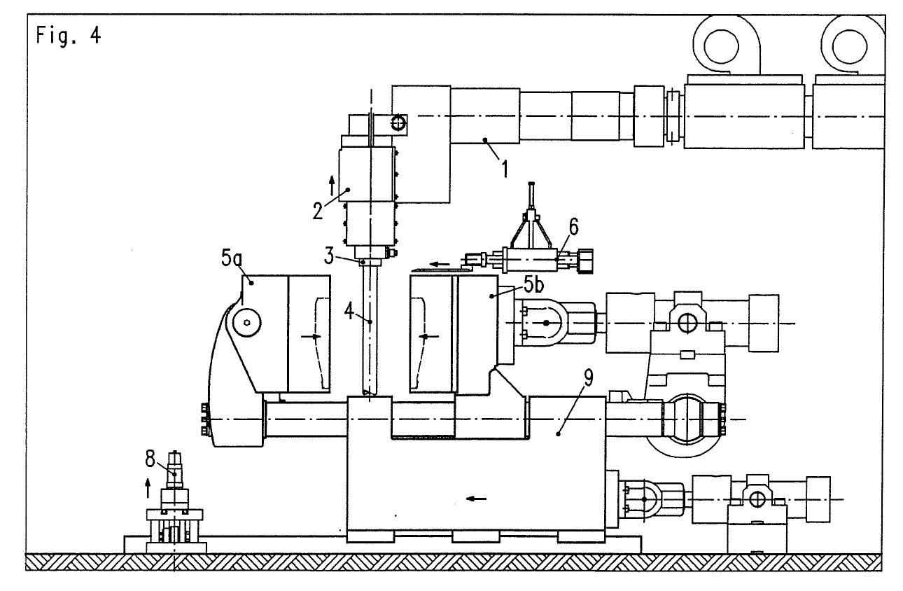

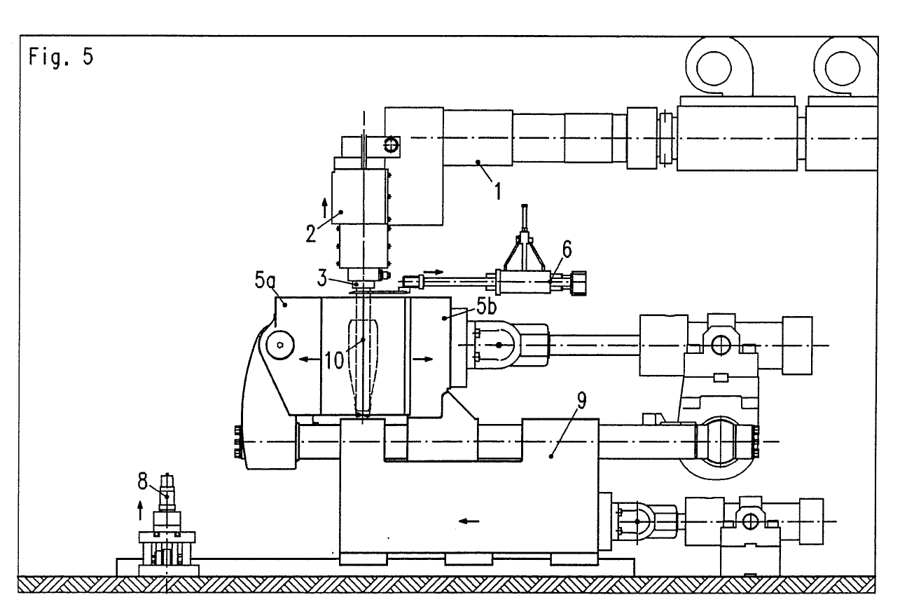

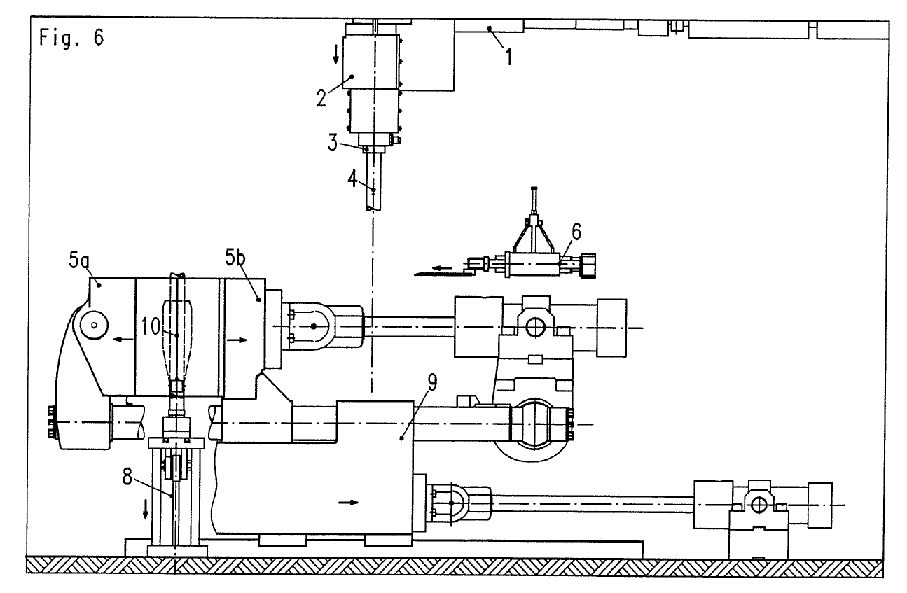

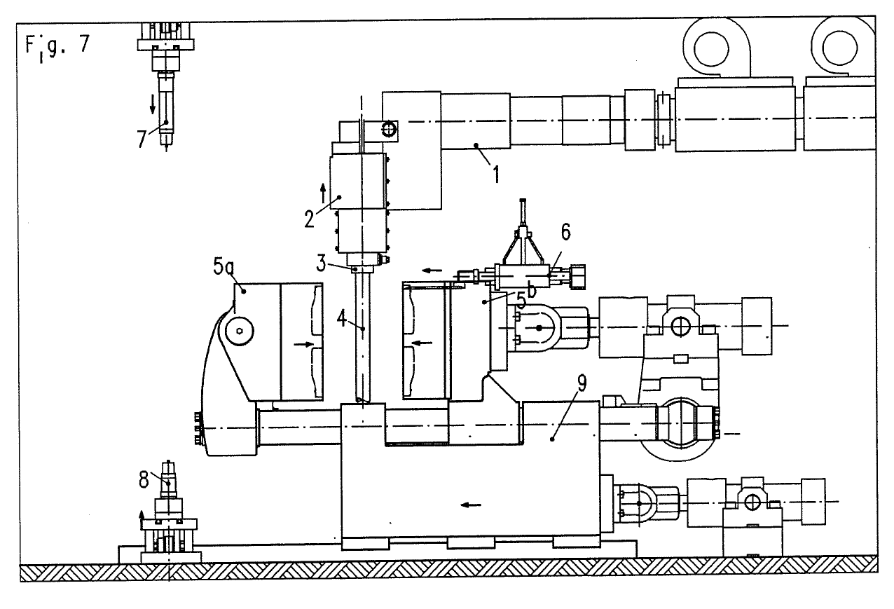

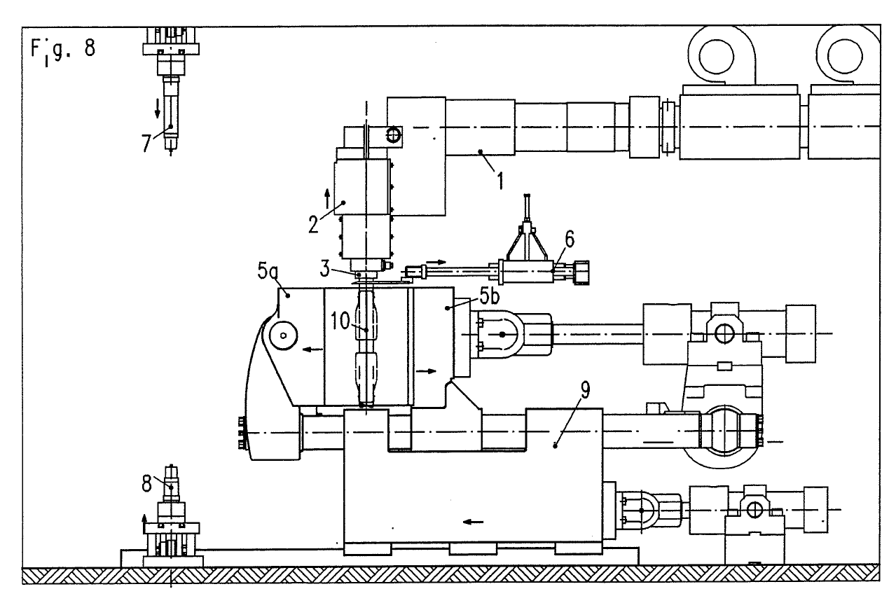

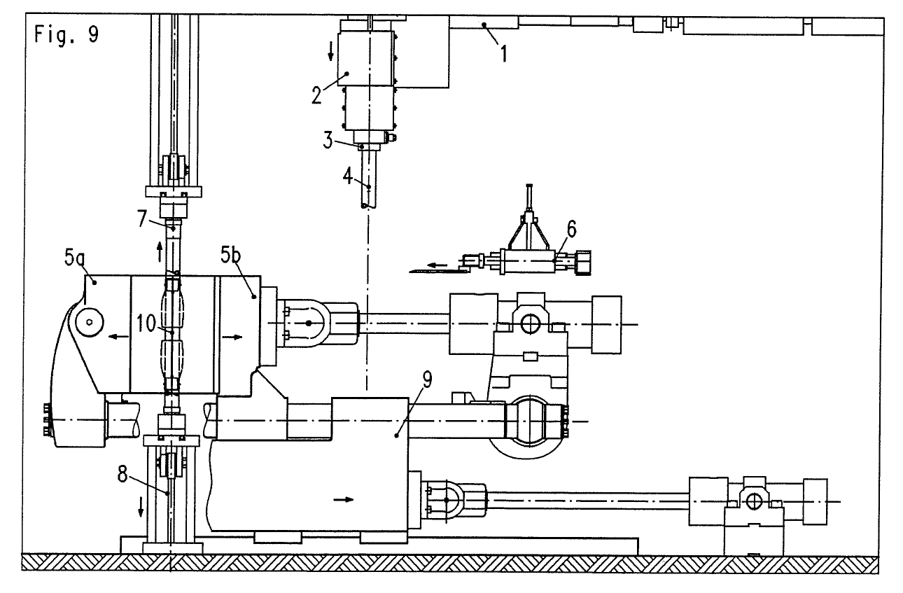

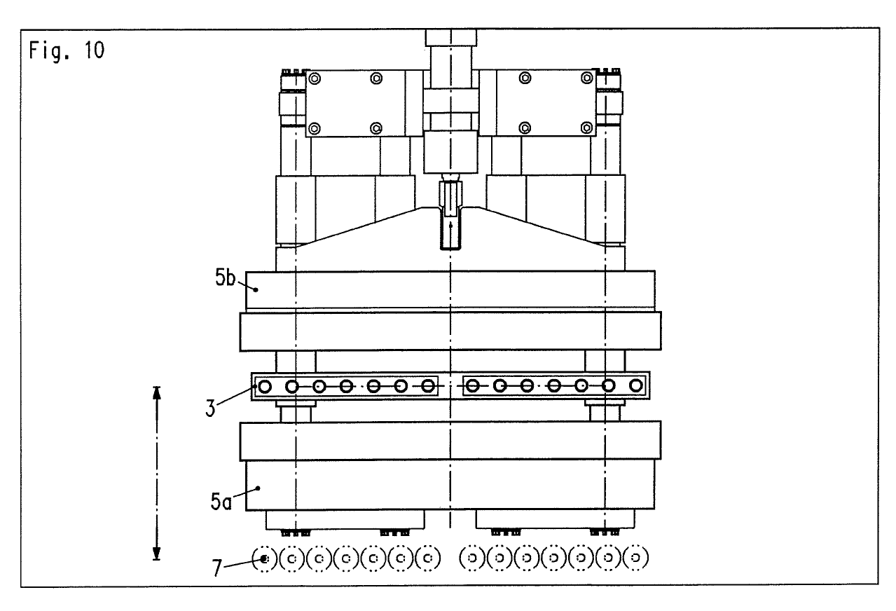

Referring now to FIGS. 1 to 10, an embodiment of an apparatus for manufacturing hollow articles made from thermoplastic materials is shown.

The parison head 2 which is arranged downstream of the extruder 1 contains one die or a plurality of parison dies 3 located along a line, through which the tube or parison 4 consisting of thermoplastic material is extruded continuously or also discontinuously.

After the necessary length of the parison 4 has been reached for the article to be finished, the mold system 5 arranged underneath the parison head 2, which system is oriented in line with the parison dies 3, closes round the parison portion(s) then yielding the “preform(s) 10”, which is/are subsequently severed from the following material. The closed mold 5a, 5b with the preform(s) 10 is then moved at a right angle relative to the mold-parting plane by a minimal distance possible, which just takes into account the geometrical dimensions of the parison head 2 and the top blowing device 7 stationarily arranged in the end position of the travel path of the mold system, irrespective of how many parallel-arranged cavities are built up.

In an additional variant in the case of the simultaneously used bottom blowing device 8, the device is positioned along the same line underneath the mold system 5. Together with the “separation from the following material”, the extruder 1 is lifted upwards in the case of continuous extrusion to ensure free transportation of a new parison 4 of the required length for the article to be made.

After the mold system has reached its position opposite to the parison die position, the top blowing device 7 or the bottom blowing device 8 or both devices move simultaneously into an end of the preform 10 held open in the mold so as to shape the article in the known way using a blowing medium.

While the preform 10 is shaped in the closed mold 5 in this position of the mold system to obtain the hollow article and is subsequently cooled by means of cooling channels incorporated into the mold, a new parison portion 4 already exits out of the parison die(s) 3 in the case of continuous extrusion. This process can be coordinated in time with the shaping and cooling and, which is not part of the application, with the removal of the finish-blown hollow article(s) in the blow mold 5 such that a preform 10 of precisely the right length is present in the preform station when the opened mold 5 has returned from its advanced position into the preform station for receiving a new preform 10 and the extruder system has been lowered again.

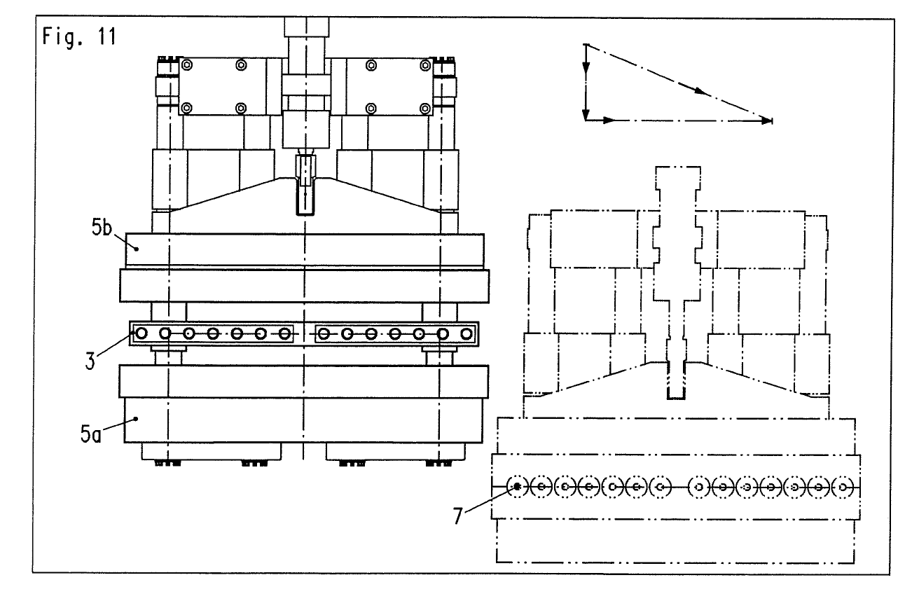

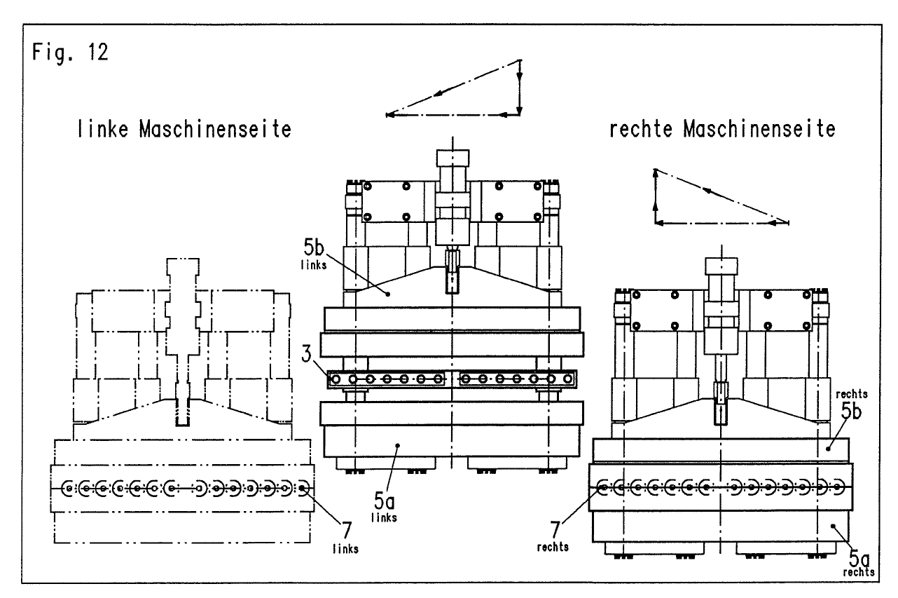

Referring now to FIGS. 11 and 12, an another embodiment of an apparatus for manufacturing hollow articles made from thermoplastic materials is shown.

The parison head 2 which is arranged downstream of the extruder 1 contains one or a plurality of parison dies 3 through which the parison consisting of thermoplastic material is extruded continuously or also discontinuously. After the necessary length of the parison has been achieved for the article to be finished, the mold system 5 arranged underneath the parison head 2, which is oriented in line with the parison dies 3, closes round the parison portion(s) 4 which yield(s) the “preform(s)” and which is/are then severed from the following material. The closed mold 5 with the preform(s) 10 is then moved obliquely towards the blowing station as shown by the movement triangle in FIG. 11. The lateral path component depends on the width of the mold mounting plate used (particularly in cases where two mold systems are used).

After the mold system has reached its laterally offset position in front of the parison die position, the “top blowing device” or the “bottom blowing device” or (in the case of two superposed preforms) both devices move simultaneously into the preform ends kept open in the mold so as to shape the articles in the known way using a blowing medium.

While the preform is shaped in the closed mold of the mold system to obtain the hollow article and is then cooled by means of cooling channels incorporated into the mold, a new parison portion already exits out of the parison die(s) in the case of continuous extrusion. This process can be coordinated in time such that a preform of precisely the right length is present in the preform station whenever a second mold system can move under the parison head position that has now become free. Instead of a “single-shuttle machine”, one talks about a “double shuttle machine” as shown in FIG. 12.

It will be understood that modifications and variations may be effected without departing from the scope of the novel concepts of the present invention, but it is understood that this application is limited only by the scope of the appended claims.

1. A blow molding machine comprising:
a preform station having arranged thereon at least one extruder including at least one downstream parison head,
at least one blowing station on which a blowing device is arranged with at least one blowing and calibrating mandrel, and
at least one mold system having a blow mold having two mold halves, the blow mold arranged underneath the at least one parison head to accommodate a thermally plasticated parison extruded out of the at least one parison head between the opened mold halves, the blow mold being moved into the blowing station after the mold halves have been closed,
wherein the at least one blowing station is arranged frontally in front of the preform station and in parallel with the mold system.

2. The blow molding machine according to claim 1, wherein the at least one blowing station is arranged frontally in front of the preform station such that the mold system is movable with the blow mold in a direction perpendicular to the mold-parting plane between the preform station and the blowing station.

3. The blow molding machine according to claim 1, wherein the distance between the preform station and the at least one blowing station is minimal and just takes into account the geometrical dimensions of the at least one parison head and the blowing device.

4. The blow molding machine according to claim 1, wherein preferably two blowing stations are arranged frontally in front of the preform station such that preferably two mold systems are movable with their blow molds obliquely relative to the mold-parting plane between the preform station and the blowing stations.

5. The blow molding machine according to claim 1, wherein the blowing device is at least one stationarily-arranged top blowing device.

6. The blow molding machine according to claim 5, wherein the blowing device is liftable to such an extent that the at least one inflated hollow article held on the blowing and calibrating mandrel does not impede the movement of the blow mold to the preform station.

7. The blow molding machine according to claim 1, wherein the blowing device comprises at least one stationarily-arranged bottom blowing device.

8. The blow molding machine according to claim 7, wherein the blowing device can be lowered to such an extent that the at least one inflated hollow article held on the blowing and calibrating mandrel does not impede the movement of the blow mold to the preform station.

9. The blow molding machine according to claim 1, wherein the blowing device comprises at least one stationarily-arranged top blowing device and at least one stationarily-arranged bottom blowing device, and wherein the top blowing device and/or the bottom blowing device can be lifted or lowered to such an extent that the inflated hollow articles held on the blowing and calibrating mandrels do not impede the movement of the blow mold to the preform station.

10. The blow molding machine according to claim 1, wherein the at least one extruder is movable with the at least one parison head along a curvature vertically upwards and downwards.

11. The blow molding machine according to claim 1, wherein the at least one extruder is movable with the at least one parison head along a straight path vertically upwards and downwards.

12. A method for manufacturing hollow articles by blow molding, wherein, after receiving at least one thermally plasticated parison, the at least one blow mold of a blow molding machine is moved on a preform station vertically or obliquely relative to its mold-parting plane to at least one blowing station arranged frontally in front of the preform station.

13. The method according to claim 12, wherein a thermally plasticated parison is extruded discontinuously out of a die of a parison head arranged downstream of an extruder.

14. The method according to claim 12, wherein a thermally plasticated parison is extruded continuously out of a die of a parison head arranged downstream of an extruder.
